(19) United States
(12) Patent Application Publication
(10) Pub. No.: US 2015/0130917 A1
(43) Pub. Date: May 14, 2015

(54) MINIATURE CONTACTLESS FINGERPRINTING DEVICE

(71) Applicant: The University of Massachusetts, Boston, MA (US)

(72) Inventors: Sam Mil'shtein, Chelmsford, MA (US); Chris Leger, Tyngsboro, MA (US); Anup Pillai, Greenville, SC (US); Zachary Durkee, Fitchburg, MA (US); Shiv D. Sharma, Beverly, MA (US)

(21) Appl. No.: 14/538,182

(22) Filed: Nov. 11, 2014

Related U.S. Application Data
(60) Provisional application No. 61/902,859, filed on Nov. 12, 2013.

(51) Int. Cl. G06K 9/00; H04N 5/33; G06K 9/22

(52) U.S. Cl. CPC G06K 9/00033; G06K 9/00026; G06K 9/22; H04N 5/33
USPC 348/77

(57) ABSTRACT

A handheld apparatus for contactless acquisition of a fingerprint image is disclosed. One such apparatus includes an enclosure and at least three digital image capture devices housed within the enclosure and arranged along an arc. The enclosure includes a hollow finger receiving area, sized and shaped to receive a finger. Each of the digital image capture devices is positioned along the arc at substantially a same distance from the finger receiving area and positioned along the arc to have a respective optical axis that lies at about 45° to another of the digital image capture devices. The optical axes intersect within the enclosure. Each digital image capture device is operable to acquire a partial fingerprint image of the finger in a contactless manner. Each partial fingerprint image corresponds to a different side of the finger. The acquired fingerprint images combine to produce a nail-to-nail fingerprint image.

### CROSS REFERENCE TO RELATED APPLICATIONS

This application claims the benefit of U.S. Provisional Application 61/902,859 (“Miniature Contactless Fingerprinting Device”), filed Nov. 12, 2013, the contents of which is entirely incorporated by reference herein.

### BACKGROUND OF THE INVENTION

Some conventional systems for acquiring fingerprint images rely on physical contact between the soft tissue of the examined finger and a scanning element. Even this small degree of contact distorts the distance between fingerprint ridges. When such systems are used with non-compliant individuals, the additional force used to fingerprint such individuals often results in increased pressure-induced distortions of the fingerprint. Another common cause of distortion is movement of the examined finger while the scan is taking place. Conventional systems for acquiring fingerprint images are bulky, making them impractical for field use.

### SUMMARY

An embodiment disclosed herein is a handheld apparatus for contactless acquisition of a fingerprint image. The handheld apparatus comprises an enclosure that includes a hollow finger receiving area sized and shaped to receive a finger and at least three digital image capture devices housed within the enclosure and arranged along a circular arc. Each of the digital image capture devices is positioned along the circular arc at substantially a same distance from the finger receiving area. Each of the digital image capture devices is positioned along the circular arc to have a respective optical axis that lies at about 45° to another of the digital image capture devices. The optical axes intersect within the enclosure. Each of the digital image capture devices is operable to acquire a partial fingerprint image of the finger in a contactless manner. Each of the partial fingerprint images corresponds to a different side of the finger, such that the acquired fingerprint image, when combined, produce a nail-to-nail fingerprint image.

An embodiment disclosed herein is a system comprising an imaging processing device and a handheld contactless fingerprint image apparatus. The image processing device is operable to combine acquired partial fingerprint images into a nail-to-nail fingerprint image.

### BRIEF DESCRIPTION OF THE DRAWINGS

FIG. 1 depicts a front view of a handheld contactless fingerprint imaging apparatus, according to some embodiments.

FIG. 2 illustrates the spatial arrangement of various components of a handheld contactless fingerprint imaging apparatus, according to some embodiments.

FIG. 3 is a block diagram of various components of handheld contactless fingerprint imaging apparatus, according to some embodiments.

FIG. 4 is a flowchart illustrating operation of a handheld contactless fingerprint imaging apparatus, according to some embodiments.

FIG. 5 shows left-side, center, and right-side images captured by a handheld contactless fingerprint imaging apparatus, according to some embodiments.

FIG. 6 shows left-side, center, and right-side images after post-processing as described in connection with FIG. 4, according to some embodiments.

FIG. 7 shows a nail-to-nail fingerprint image produced by combining partial fingerprint image, according to some embodiments.

FIG. 8 shows a nail-to-nail fingerprint image after application of a binarization process, according to some embodiments.

### DETAILED DESCRIPTION

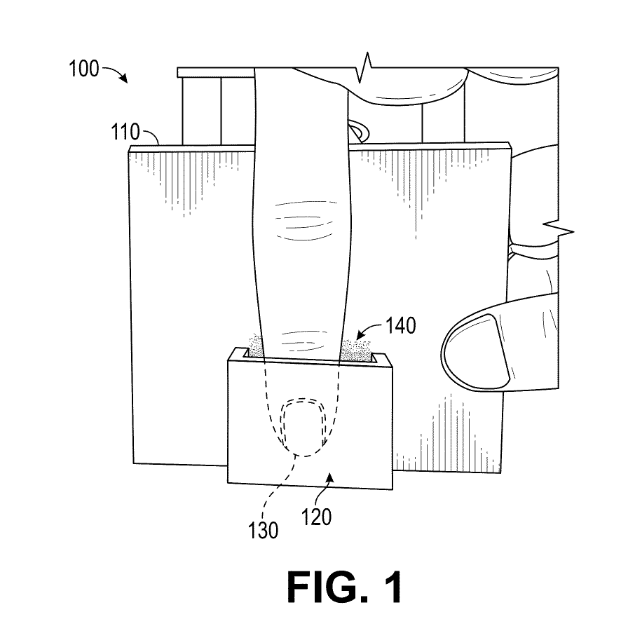

FIG. 1 depicts a front view of a handheld contactless fingerprint imaging apparatus 100, according to some embodiments. Shown in FIG. 1 is an enclosure 110 with a hollow finger receiving area 120 which is sized and shaped to receive at least the fingerprint-bearing distal portion 130 of a user's finger. As can be seen in FIG. 1, the user inserts the distal finger portion 130 through an aperture 140 in the finger receiving area 120. As will be explained in further detail below, digital image capture devices within enclosure 110 capture separate images of the fingerprint-bearing sides of finger 130, which can be combined into a nail-to-nail fingerprint image. In some embodiments, enclosure 110 is opaque and visible light sources housed within enclosure 110 illuminate finger 130 during image acquisition. The image acquisition process may be automatically triggered by sensing the presence of finger 130 in finger receiving area 120, or the process may be started manually by a button or switch.

As can be seen in FIG. 1, fingerprint imaging apparatus 100 is mobile and small enough to be carried in a user's hand, which allows apparatus 100 to be used in the field by law enforcement officers or security personnel. As will be described below, fingerprint imaging apparatus 100 is also contactless, that is, finger 130 does not touch a camera lens or other image capture surface during the fingerprint acquisition process. Contactless operation allows apparatus 100 to be used on non-compliant individuals or even handcuffed individuals. In contrast, pressure-induced distortions in the usually result when force is used to obtain fingerprints.

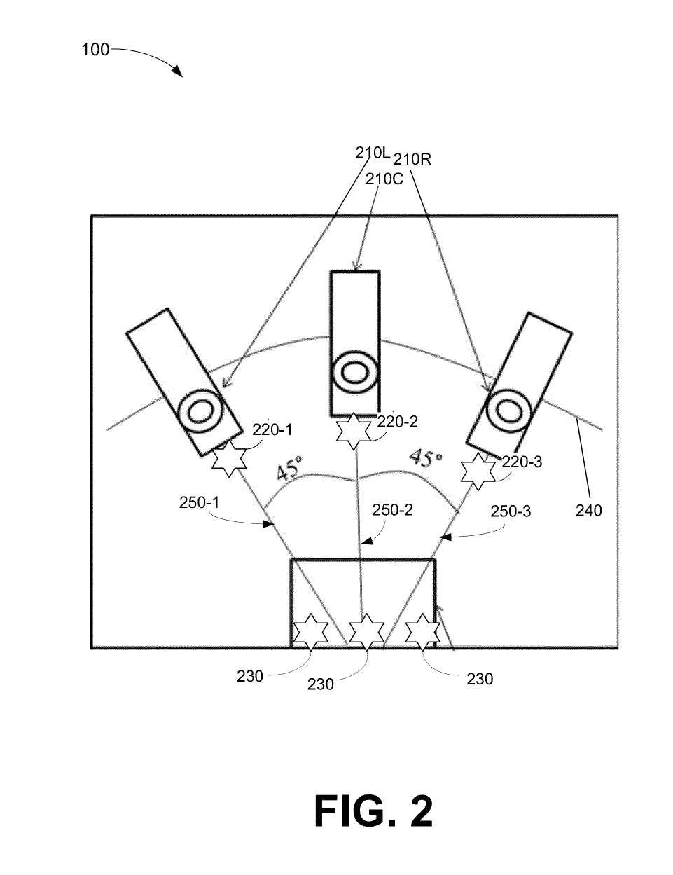

FIG. 2 illustrates the spatial arrangement of various components of handheld contactless fingerprint imaging apparatus 100, according to some embodiments. In this embodiment, fingerprint imaging apparatus 100 includes a set of digital image capture devices 210, one or more visible light sources 220, and one or more infrared light sources 230. Digital image capture device 210 may be implemented by a digital camera having a charge coupled device (CCD) image sensor and lens. Visible light source 220 and infrared light sources 230 may be implemented by one or more light emitting diode (LED) modules, arrays, or strips.

As shown in FIG. 2, digital image capture devices 210 are arranged along a circular arc 240, so that each digital image capture device 210 is about the same distance from finger receiving area 120. This distance depends on various characteristics of digital image capture devices 210, such as focal length, resolution, light sensitivity, etc. The resolution of capture devices 210 is a design choice based on cost and other considerations. In some embodiments, the resolution used is one that allows 1 μm pores to be clearly seen.

Each of digital image capture devices 210 has an optical axis 250-1, -2, -3, and these optical axes 250 intersect within finger receiving area 120. The example fingerprint imaging apparatus 100 shown in FIG. 2 uses three image capture devices 210L, 210C, 210R, and the optical axis 250 of the left device 210L is at approximately a 45° angle from the optical axis 250 of the center device 210C. Similarly, the optical axis 250 of the right device 210R is at approximately a 45° angle from the optical axis 250 of the center device 210C. With this arrangement, center digital image capture device 210C is positioned perpendicular to the flat portion of the fingerprint-bearing surface and thus acquires an image of the larger flat portion of the finger. Side digital image capture devices 210L and 210R are each positioned to acquire an image of one of the smaller lateral (side) portions. Digital image capture devices 210A-C thus acquire separate partial fingerprint images that can be combined into a complete nail-to-nail fingerprint image.

Visible light sources 220 are positioned to provide illumination of finger receiving area 120, in the visible spectrum. Such light may be referred to as white light or daylight. In this example, visible light sources 220A-C are positioned underneath digital image capture devices 210A-C thus providing sufficient visible light along optical axes 250 to illuminate finger 130 within finger receiving area 120.

In this example, infrared light sources 230 are also included in handheld contactless fingerprint imaging apparatus 100 in order to show “liveliness” of the examined finger. Infrared light sources 230 provide light in the near infrared spectrum (e.g. 620 nm to 800 nm). Digital image capture devices 210A-C are therefore activated a second time to acquire separate blood vessel images. The blood vessel images can be combined to form a complete nail-to-nail blood vessel image. In this embodiment, infrared light sources 230 are positioned behind, and relatively close to, finger 130. However, this other arrangements are possible, as long as finger 130 is sufficiently illuminated while within finger receiving area 120.

The infrared light penetrates finger 130 and is absorbed by oxygenated hemoglobin in the blood, thus generating a map of the blood vessels in finger 130. The blood vessel image can be used to determine that the corresponding fingerprint image, acquired at the same time, was acquired from a live human rather than from a severed part, since only a “live” finger will have blood flowing through the vessels. The blood vessel image can also be used to distinguish human tissue from an artificial replica, which doesn't have flow. In some embodiments, the blood vessel images are enhanced using image processing algorithms to sharpen the images of the vessels.

Digital image capture devices 210A-C are activated or triggered at substantially the same time so that images from all three finger regions are acquired simultaneously. In some embodiments, image capture with infrared illumination is performed first, followed by image capture with daylight illumination. In some embodiments, light sources 220 are enabled for a specific duration and are disabled otherwise, thus conserving power and increasing lifetime. For example, visible light sources 220 and/or infrared light sources 230 may be turned on at the beginning of the image acquisition process and then turned off when the image has been acquired.

Image acquisition time for digital image capture devices 210 is on the order of a few milliseconds, a time period shorter than the typical human reaction time. Thus, the partial fingerprint images (visible light) and the blood vessel images (infrared light) are acquired before the user being fingerprinted has time to move his finger.

The partial fingerprint images are stored within handheld contactless fingerprint imaging apparatus 100, for example, in a memory that resides within digital image capture devices 210, or in a memory that is accessible to digital image capture devices 210. The partial fingerprint images may be offloaded to a separate database, computer, or other system at a later time. Some embodiments of fingerprint imaging apparatus 100 have 4 GB of storage, which allows collection of about 4000 fingerprints before offloading is needed. Put another way, each digital image capture device 210 in such an embodiment has the capacity to store about 4,000 images.

Notably, both digital image capture devices 210 and finger 130 remain stationary during the image acquisition process. In contrast, conventional fingerprint imaging devices roll or rotate the finger during image acquisition, or use image capture devices which rotate around the finger during acquisition.

This fixed position for digital image capture devices 210 can be achieved in several different ways. In some embodiments, the digital image capture devices 210 are fixedly and/or securely mounted within enclosure 110. In other embodiments digital image capture devices 210 are moveable (e.g., to different positions around the arc, or to a different distance from finger receiving area 120), but digital image capture devices 210 nonetheless remain stationary during the image capture.

The small size and light weight of fingerprint imaging apparatus 100 allows it be used in a variety of applications. For example, fingerprint imaging apparatus 100 can be used for fingerprint capture at various locations such as a police station, a border control station, or an airport, for comparison against fingerprint databases. As noted above, because fingerprint imaging apparatus 100 is contactless, fingerprints can be taken in the field from uncooperative individuals and/or individuals in handcuffs.

Fingerprint imaging apparatus 100 can also be used within perimeter control or security equipment to control which users enter into a restricted access area (i.e., at gates, doors, etc.). Apparatus 100 can also be used to control access to various types of electronic devices such as automatic teller machines (ATMs), computers, medical equipment, and storage enclosures or boxes. Fingerprint imaging apparatus 100 can be integrated with terminals used for various types of financial transactions, such as credit card terminals, point-of-sale terminals, and electronic benefits transfer (EBT) terminals. Fingerprint imaging apparatus 100 can be integrated into medical benefits processing to insure that only an authorized individual receives reimbursement for a medical procedure, or integrated into medical records processing to insure that only an authorized individual views a medical or patient record.

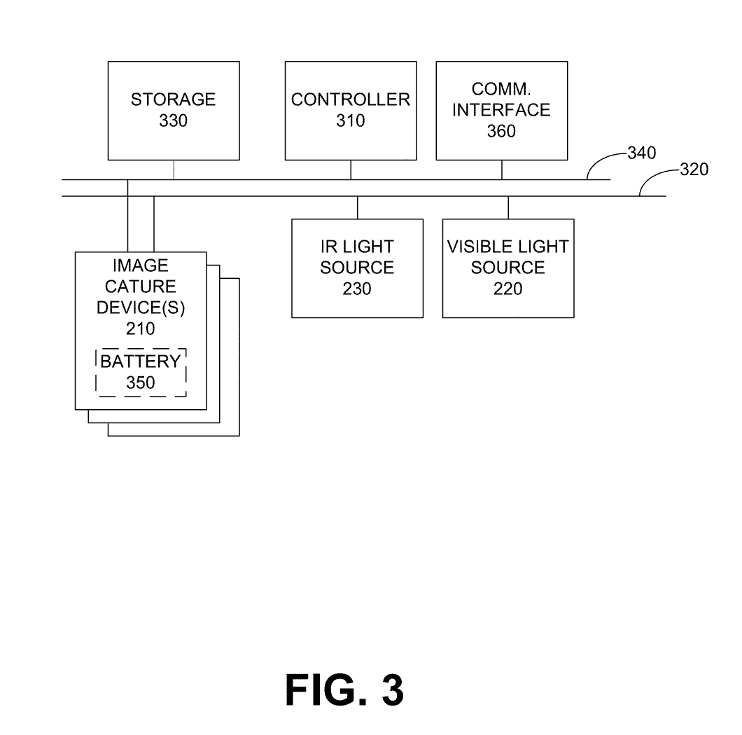

FIG. 3 is a block diagram of various components of handheld contactless fingerprint imaging apparatus 100 according to some embodiments. A controller 310 is coupled to digital image capture devices 210, visible light sources 220, and infrared light sources 230 via a control bus 320. Controller 310 sends control signals to digital image capture devices 210 to start and stop the image acquisition process. Controller 310 sends control signals to visible light sources 220 and infrared light sources 230 to enable illumination at the start of acquisition and to disable illumination when acquisition is over.

Images acquired by digital image capture devices 210 are stored in storage device 330, which is accessible via a data bus 340. Controller 310 may direct this storage operation, or the storage may be handled by the digital image capture device 210 itself In the example embodiment of FIG. 3, storage device 330 is shown as a separate logical component, but storage device 330 may be incorporated into the digital image capture device 210.

Digital image capture device 210 includes a battery 350, which may be rechargeable through an external power source. The battery may be recharged, for example, through a Universal Serial Bus (USB) cable.

A communications interface 360 is coupled to control bus 320 and to data bus 340. Communications interface 360, which may be implemented via USB or a wireless network such as IEEE 802.11, allows images stored in storage device 330 to be transferred out of handheld contactless fingerprint imaging apparatus 100.

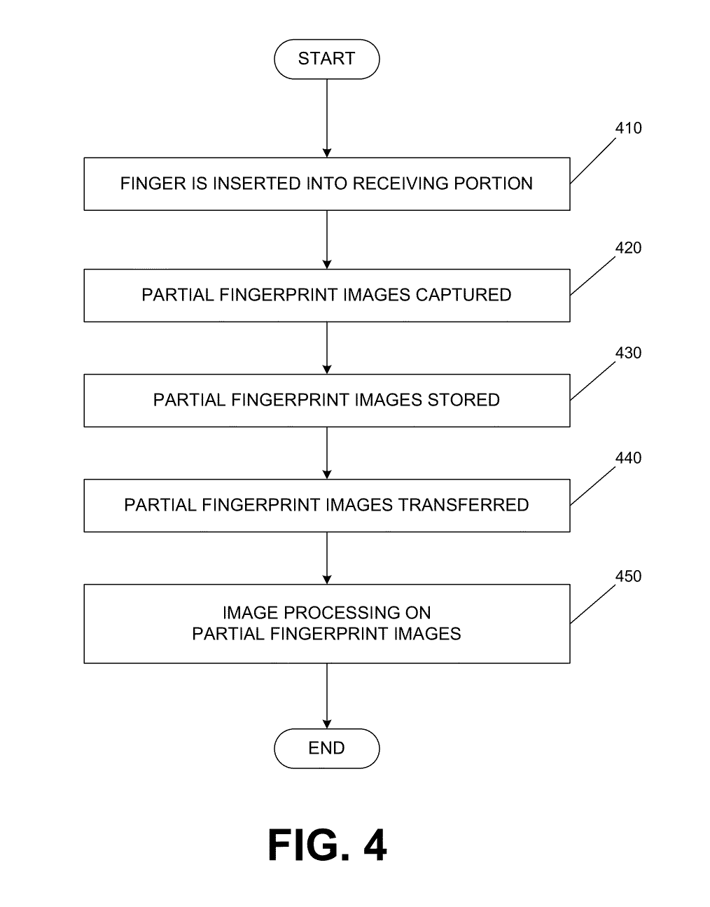

FIG. 4 is a flowchart illustrating operation of a handheld contactless fingerprint imaging apparatus 100, according to some embodiments. At block 410, a user inserts the fingerprint-bearing distal portion of his finger 130 (FIG. 1) into finger receiving area 120 (FIGS. 1 and 2). At block 420, digital image capture devices 210 capture respective partial fingerprint images. Optionally, digital image capture devices 210 may also capture blood vessel images for the same fingerprints. As explained above, the image capture process may involve turning on and turning off visible light and/or infrared light sources. At block 430, a set of partial fingerprint image is stored within handheld contactless fingerprint imaging apparatus 100, for example, storage device 330. In embodiments which capture blood vessel images in addition to fingerprint images, these blood vessel images are also stored.

At block 440, a set of partial fingerprint image is stored within handheld contactless fingerprint imaging apparatus 100, for example, storage device 330. At block 450, one or more sets of partial fingerprint image and/or blood vessel images are transferred, via communications interface 360, to an external system. Handheld contactless fingerprint imaging apparatus 100 may provide a user interface through which an operator can select the particular images that are transferred.

At block 460, a computing system performs post-processing on the partial fingerprint images received from handheld contactless fingerprint imaging apparatus 100. The computing system may use software such as Adobe Photoshop®, MATLB®, or any suitable image processing software.

One example of post-processing is “stitching” of separate partial fingerprint images into a single composite nail-to-nail fingerprint image. This stitching may be performed by an image processing program and may involve human intervention by an operator that is knowledgeable about fingerprints and digital fingerprint imaging. For example, the human operator may use the image processing program to identify points of interest called “minutiae” and use these minutiae to determine where the edge of one partial image should be joined to the edge of another partial image, i.e., the operator chooses the points where the images are “stitched” together.

Another type of post-processing that may be performed on a nail-to-nail fingerprint image at block 460 involves various adaptations that allow a fingerprint captured by a contactless system to be compared to a fingerprint captured by a contact-based system. Several types of differences exist between contactless and contact-based fingerprint images. One such difference the grayscale variation exhibited in contactless fingerprint images. The use of global thresholding during binarization leads to loss of useful information, so block 460 may perform adaptive binarization. Block 460 may use a combination of region-based thresholding and a filter-based approach.

Adaptive histogram equalization is another technique that can be applied by the post-processing at block 460 to the contactless fingerprint image. This may be applied before binarization, since equalization ensures that the image is consistent in brightness and contrast, which in turn results in good quality binarization. Equalization can be performed in software, or by specialized image processing hardware.

One difference between contactless and contact-based fingerprint images is that the background and foreground are inverted. For example, ridges show up in black in a contacted-based image and in white in a contactless image, while valleys exhibit the opposite behavior. The post-processing at block 460 may therefore invert, or take the complement of, each pixel in the contactless fingerprint image. This inversion may be performed before or after binarization.

Aspect ratio is another difference between contactless and contact-based fingerprint images that may be addressed by the post-processing at block 460. The aspect ratio of the contactless and contact-based images is determined, and the images are then scaled accordingly, depending on the calculated aspect ratio. Bicubic interpolation may be used to scale the images. Bilinear interpolation and nearest neighbor may also be used if quick computation time is not a concern.

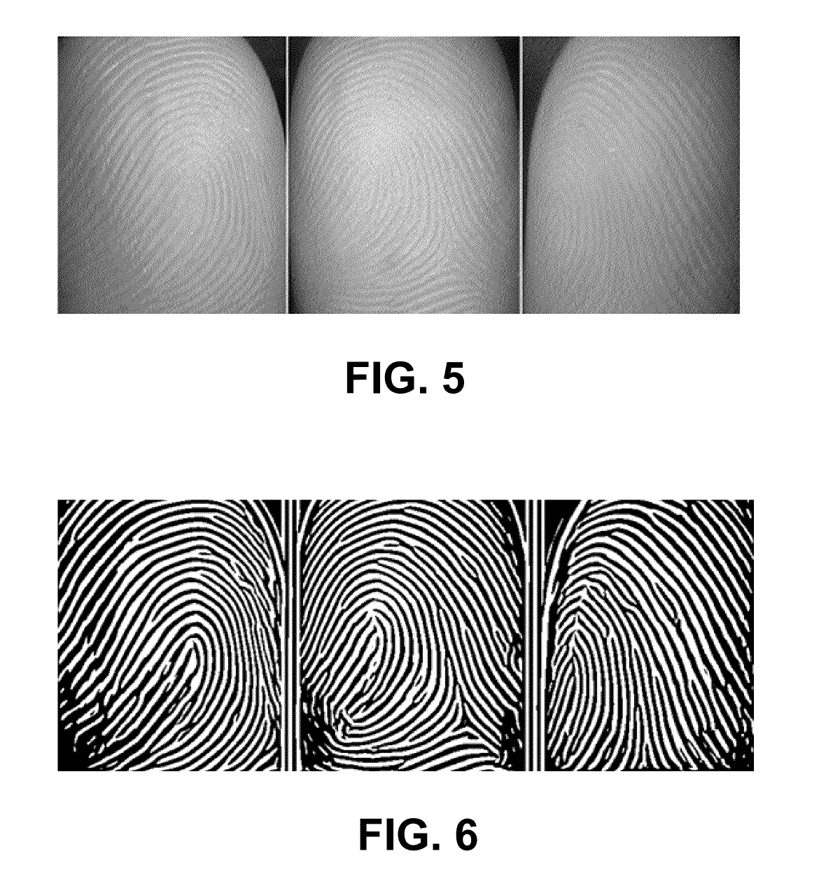

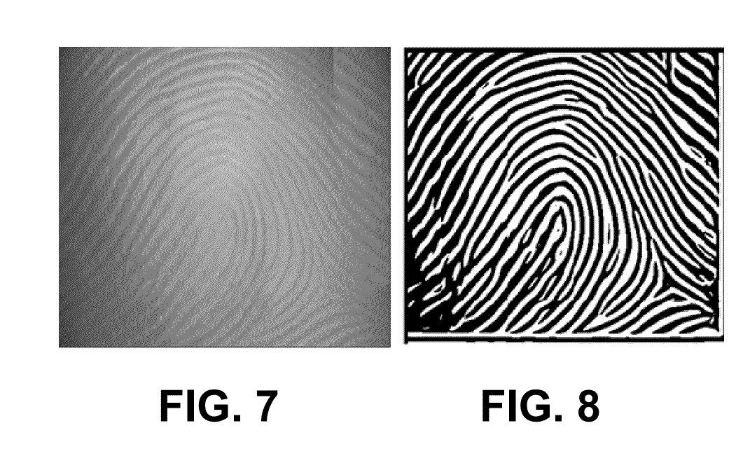

FIG. 5 shows left-side, center, and right-side images captured by handheld contactless fingerprint imaging apparatus 100 according to some embodiments. FIG. 6 shows left-side, center, and right-side images after post-processing as described in connection with FIG. 4, according to some embodiments. FIG. 7 shows a nail-to-nail fingerprint image produced by combining (“stitching”) three partial fingerprint images, according to some embodiments. FIG. 8 shows a nail-to-nail fingerprint image after application of a binarization process, according to some embodiments.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiments disclosed for carrying out this invention, but that the invention will include all embodiments falling within the scope of the present application.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

The terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A handheld apparatus for contactless acquisition of a fingerprint image, the handheld apparatus comprising:
an enclosure that includes a hollow finger receiving area sized and shaped to receive a finger; and
at least three digital image capture devices housed within the enclosure and arranged along a circular arc;
each of the digital image capture devices positioned along the circular arc at substantially a same distance from the finger receiving area and positioned along the circular arc to have a respective optical axis that lies at about 45° to another of the digital image capture devices, wherein the optical axes intersect within the enclosure,
each the digital image capture devices operable to acquire a partial fingerprint image of the finger in a contactless manner, each of the partial fingerprint images corresponding to a different side of the finger, such that the acquired fingerprint image, when combined, produce a nail-to-nail fingerprint image.

2. The handheld apparatus of claim 1, wherein the at least three digital image capture devices are further operable to acquire the partial fingerprint images substantially simultaneously while the digital image capture devices are stationary.

3. The handheld apparatus of claim 1, further comprising:
one or more visible light sources housed within the enclosure and configured to provide illumination, in a visible light spectrum, for the digital image capture devices,
wherein the digital image capture devices are further operable to acquire the partial fingerprint images while the finger receiving area is illuminated by the one or more visible light sources.

4. The apparatus of claim 1, further comprising:
an infrared light source housed within the enclosure and configured to provide illumination, in an infrared spectrum, for at least one of the digital image capture devices,
wherein the at least one of the digital image capture devices is further operable to acquire a blood vessel image while the finger receiving area is illuminated by the infrared light source.

5. The apparatus of claim 1, further comprising:
one or more infrared light sources housed within the enclosure and configured to provide illumination, in an infrared spectrum, for the digital image capture devices,
wherein each of the digital image capture devices is further operable to acquire a blood vessel image while the finger receiving area is illuminated by the one or more infrared light sources, and
wherein each of the blood vessel images corresponds to respective sides of the finger, such that the acquired blood vessel image, when combined, produce a nail-to-nail blood vessel image.

6. The apparatus of claim 1, further comprising a communications interface operable to transfer the partial fingerprint images to an external system.

7. The apparatus of claim 6, wherein the communications interface corresponds to a universal serial bus (USB) interface.

8. The apparatus of claim 6, wherein the communications interface corresponds to a wireless network interface.

9. The apparatus of claim 1, further comprising a communications interface operable to transfer the nail-to-nail blood vessel image to an external system.

10. The apparatus of claim 9, wherein the communications interface corresponds to a Universal Serial Bus (USB) interface.

11. The apparatus of claim 9, wherein the communications interface corresponds to a wireless network interface.

12. The apparatus of claim 1, further comprising a storage device housed within the enclosure, wherein each of the digital image capture devices is further operable to store at least one of the respective partial fingerprint image and the nail-to-nail blood vessel image in the storage device.

13. The apparatus of claim 12, wherein the storage device corresponds to a memory.

14. The apparatus of claim 1, further comprising a storage device housed within the enclosure and in data communication with the digital image capture devices, wherein each of the digital image capture devices is further operable to transfer at least one of the respective partial fingerprint image and the nail-to-nail blood vessel image to the storage device.

15. The apparatus of claim 12, wherein the storage device corresponds to a memory.

16. The apparatus of claim 1, further comprising a battery housed within the enclosure and electrically coupled to the digital image capture devices.

17. The apparatus of claim 1, wherein the battery is rechargeable from an external power source.

18. The apparatus of claim 17, wherein the external power source is connectable to the battery via a universal serial bus (USB) connector.

19. The apparatus of claim 1, wherein the enclosure is sized and shaped to receive only a distal portion of the finger.

20. A system comprising the apparatus of claim 1, and further comprising an imaging processing device operable to combine the acquired partial fingerprint images into the nail-to-nail fingerprint image.
